(19) United States
(12) Patent Application Publication
(10) Pub. No.: US 2013/0194304 A1
(43) Pub. Date: Aug. 1, 2013

(54) COORDINATE-SYSTEM SHARING FOR AUGMENTED REALITY

(71) Applicants: Stephen Latta, Seattle, WA (US); Darren Bennett, Seattle, WA (US); Peter Tobias Kinnebrew, Seattle, WA (US); Kevin Geisner, Mercer Island, WA (US); Brian Mount, Seattle, WA (US); Arthur Tomlin, Bellevue, WA (US); Mike Scavezze, Bellevue, WA (US); Daniel McCulloch, Kirkland, WA (US); David Nister, Bellevue, WA (US); Drew Steedly, Redmond, WA (US); Jeffrey Alan Kohler, Redmond, WA (US); Ben Sugden, Woodinville, WA (US); Sebastian Sylvan, Seattle, WA (US)

(72) Inventors: Stephen Latta, Seattle, WA (US); Darren Bennett, Seattle, WA (US); Peter Tobias Kinnebrew, Seattle, WA (US); Kevin Geisner, Mercer Island, WA (US); Brian Mount, Seattle, WA (US); Arthur Tomlin, Bellevue, WA (US); Mike Scavezze, Bellevue, WA (US); Daniel McCulloch, Kirkland, WA (US); David Nister, Bellevue, WA (US); Drew Steedly, Redmond, WA (US); Jeffrey Alan Kohler, Redmond, WA (US); Ben Sugden, Woodinville, WA (US); Sebastian Sylvan, Seattle, WA (US)

(21) Appl. No.: 13/364,211

(22) Filed: Feb. 1, 2012

(51) Int. Cl. G09G 5/377

(52) U.S. Cl. 345/633

(57) ABSTRACT

A method for presenting real and virtual images correctly positioned with respect to each other. The method includes, in a first field of view, receiving a first real image of an object and displaying a first virtual image. The method also includes, in a second field of view oriented independently relative to the first field of view, receiving a second real image of the object and displaying a second virtual image, the first and second virtual images positioned coincidently within a coordinate system.

### BACKGROUND

An augmented-reality (AR) system enables a participant to view real-world imagery in combination with context-relevant, computer-generated imagery. Imagery from both sources is presented in the participant's field of view, and may appear to share the same physical space. An AR system may include a head-mounted display (HMD) device, which the participant wears, and through which the real-world and computer-generated imagery are presented. The HMD device may be fashioned as goggles, a helmet, visor, or other eyewear. When configured to present two different display images, one for each eye, the HMD device may be used for stereoscopic, three-dimensional (3D) display.

In AR applications in which multiple participants share the same physical environment, inconsistent positioning of the computer-generated imagery relative to the real-world imagery can be a noticeable distraction that degrades the AR experience.

### SUMMARY

Accordingly, one embodiment of this disclosure provides a method for presenting real and virtual images correctly positioned with respect to each other. The method includes, in a first field of view, receiving a first real image of an object and displaying a first virtual image. The method also includes, in a second field of view oriented independently relative to the first, receiving a second real image of the object and displaying a second virtual image, the first and second virtual images positioned coincidently within a coordinate system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an AR system and AR participants in accordance with an embodiment of this disclosure.

FIG. 2 shows cooperatively aligned fields of view of an AR participant in accordance with an embodiment of this disclosure.

FIGS. 3 and 4 show example HMD devices in accordance with different embodiments of this disclosure.

FIG. 5 shows aspects of an example imaging panel in accordance with an embodiment of this disclosure.

FIG. 6 shows aspects of an example sensory and control unit in accordance with an embodiment of this disclosure.

FIG. 7 illustrates a method for presenting real and virtual images correctly positioned with respect to each other in accordance with an embodiment of this disclosure.

FIGS. 8-13 illustrate coordinates of a virtual object specified with respect to six different frames of reference, in accordance with embodiments of this disclosure.

FIG. 14 shows a shared coordinate system on which real and virtual objects are arranged in accordance with an embodiment of this disclosure.

FIGS. 15 and 16 illustrate example methods for computing the position and orientation of a field of view in accordance with different embodiments of this disclosure.

FIG. 17 shows an example scenario in accordance with an embodiment of this disclosure.

FIG. 18 illustrates an example method for passing a virtual object between first and second AR participants in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

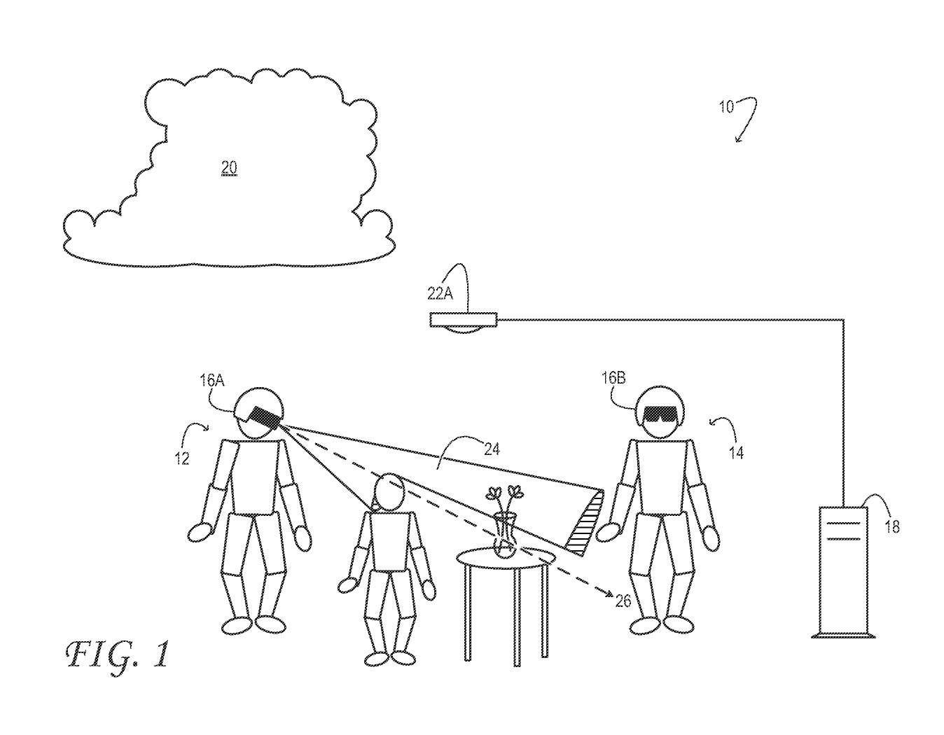

FIG. 1 shows aspects of an example AR system 10 in one embodiment. In particular, it shows first participant 12 and second participant 14 interacting with various real-world objects and non-participants in an interior living space. In other scenarios, the AR system may be used with more or fewer participants, or in an exterior space.

To experience an augmented reality, first participant 12 and second participant 14 may interact with one or more applications running within AR system 10. Aspects of the applications are run on HMD devices 16, each device including a logic unit and various other componentry, as described in further detail hereinafter. Accordingly, FIG. 1 shows HMD device 16A worn by the first participant and HMD device 16B worn by the second participant.

In some embodiments, other aspects of the applications may be run on personal computer (PC) 18 or in cloud 20. ‘Cloud’ is a term used to describe a computer system accessible via a network and configured to provide a computing service. In the various embodiments considered herein, the PC may be a desktop computer, laptop computer, tablet computer, home entertainment computer, network computing device, mobile computing device, mobile communication or gaming device, for example. The cloud may include any number of mainframe and/or server computers.

In the embodiment shown in FIG. 1, PC 18 is configured as a stationary observer of the AR environment; it is operatively coupled to camera 22A. The camera, described hereinafter with reference to another embodiment, is positioned to acquire video of the AR participants and their surroundings. In one embodiment, the PC may be configured to repeatedly update a mapping of the surroundings. Such mapping may be made available to the HMD devices of the participants via cloud 20, for example. In this manner, a plurality of HMD devices may obtain a robust map of the area they are in. In some embodiments, the HMD devices may be configured to share data back to the PC to extend and/or refine the mapping beyond the capabilities of PC 18 and camera 22A alone.

Accordingly, PC 18, cloud 20, and each HMD device 16 are operatively coupled to each other via one or more wireless communication links. Such links may include cellular, Wi-Fi, and others. In some embodiments, the PC and/or cloud may be omitted, the observation and computation functions of these components enacted in the HMD devices.

In some embodiments, the applications run within AR system 10 may include a game. More generally, the applications may be any that combine computer-generated imagery with the real-world imagery viewed by a participant. In AR system 10, the real-world and computer-generated imagery are combined via specialized imaging componentry coupled in HMD devices 16.

One approach to combining real-world and computer-generated imagery is to acquire video of the scene directly in front of a participant's eyes, to mix the video with the desired computer-generated imagery, and to present the combined imagery on a display screen viewable by the participant. However, this approach, in which all imagery is rendered on a display screen, may not provide the most realistic AR experience. A more realistic experience may be achieved with the participant viewing his environment naturally, through passive optics of the HMD device. In other words, light from observed objects travels directly to the participant's eyes through the passive optics. The desired computer-generated imagery, meanwhile, is projected into the same field of view in which the real-world imagery is received. As such, the participant's eyes receive light directly from the observed objects as well as light that is generated by the HMD device.

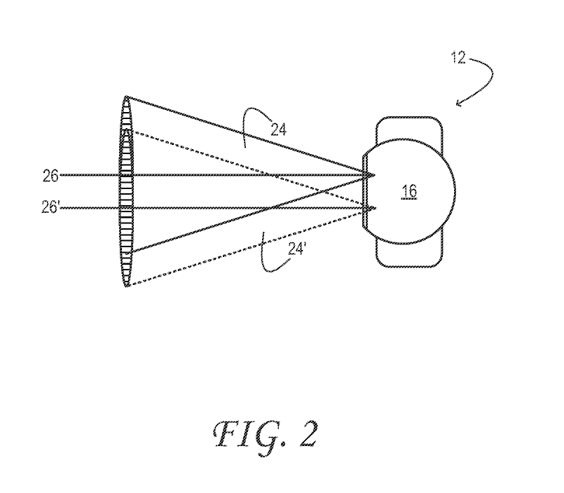

By way of example, FIG. 1 shows a first field of view 24 of first participant 12. The first field of view passes directly through HMD device 16A. The first field of view is monocular, its orientation defined by monocular line of sight 26. The angular (i.e., peripheral) extension of the first field of view differs for each plane passing through the line of sight, and is generally widest in the plane also containing the interocular axis of the participant. As shown in FIG. 1, the first field of view naturally does not extend to areas behind opaque objects. Participants having binocular vision will experience two distinct, but cooperatively aligned fields of view, as shown in FIG. 2. In FIG. 2, each line of sight (26 and 26′) has an origin positioned behind the passive optics of HMD device 16, coincident with the retinas of the wearer.

By combining naturally sighted real-world imagery with the desired computer-generated imagery, an AR system may provide a realistic AR experience. That experience may be degraded, however, by inconsistent positioning of the computer-generated imagery relative to real-world imagery, especially when two or more participants share the same physical environment.

Participants sharing the same physical environment may view the same real-world imagery and be presented analogous computer-generated imagery. From the participants' perspectives, the spatial relationships between commonly sighted real-world and computer-generated objects are likely to be significant. Ideally, participants experiencing the same augmented reality should observe the same spatial relationships between the same real and virtual objects, even if those objects are viewed from different perspectives. For example, if a first participant sees a virtual dragon flying directly above a real building, then a second participant should also see the dragon directly above the building, not to the side of it.

The disadvantage of inconsistent positioning of the display image is even more acute in scenarios where evidence of a first participant interacting with a virtual object is perceived by a second participant. In the example above, the first participant may point to the dragon, and the second participant may see him pointing. If the dragon is not positioned consistently in the fields of view of the first and second participants, it may appear to the second participant as if the first participant is pointing to something else, or to nothing at all. As another example, in a game of catch between two participants, whenever either participant catches the virtual ball, it is desirable for both of them to see the ball coming to rest in the same hand, not elsewhere.

To address the above issues, the AR systems and methods disclosed herein provide that real-world and computer-generated imagery presented to each participant are correctly positioned with respect to each other. More specifically, they result in a common coordinate system being shared among the HMD devices worn by the participants.

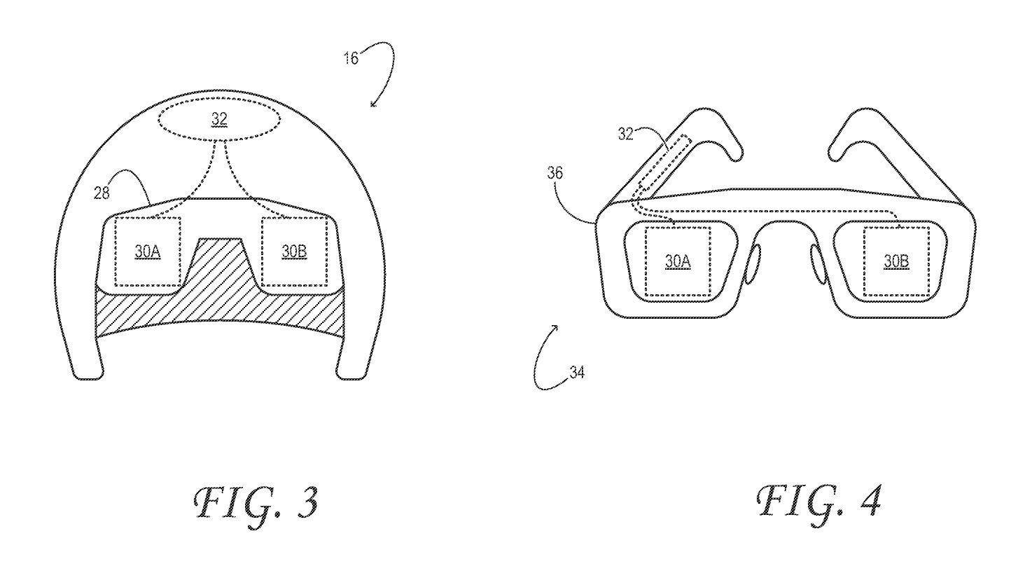

Returning now to the drawings, FIG. 3 shows an example HMD device 16 in one embodiment. HMD device 16 is a helmet having a visor 28. Between the visor and each of the wearer's eyes is arranged an imaging panel 30: imaging panel 30A is arranged in front of the right eye, 30B in front of the left eye. The HMD device also includes a sensory and control unit 32, which is operatively coupled to both imaging panels.

Imaging panels 30A and 30B are at least partly transparent, each providing a substantially unobstructed field of view in which the wearer can directly observe his physical surroundings. Each imaging panel is also configured to present, in the same field of view, a display image. By combining real-world imagery from the surroundings with a computer-generated display image, AR system 10 delivers a realistic AR experience for the wearer of HMD device 16.

Continuing in FIG. 3, sensory and control unit 32 controls the internal componentry of imaging panels 30A and 30B in order to form the desired display images. In one embodiment, sensory and control unit 32 may cause imaging panels 30A and 30B to display the same image concurrently, so that the wearer's right and left eyes receive the same image at the same time. In another embodiment, the imaging panels may project slightly different images concurrently, so that the wearer perceives a stereoscopic, i.e., three-dimensional image.

In one scenario, the display image and various real images of objects sighted through an imaging panel may occupy different focal planes. Accordingly, the wearer observing a real-world object may have to shift his corneal focus in order to resolve the display image. In other scenarios, the display image and at least one real image may share a common focal plane.

In the HMD devices disclosed herein, each imaging panel 30 is also configured to acquire video of the surroundings sighted by the wearer. The video is used to provide input to AR system 10. Such input may establish the wearer's location, what the wearer sees, etc. The video acquired by the imaging panel is received in sensory and control unit 32. The sensory and control unit may be further configured to process the video received, as disclosed hereinafter.

FIG. 4 shows another example HMD device 34. HMD device 34 is an example of AR eyewear. It may closely resemble an ordinary pair of eyeglasses or sunglasses, but it too includes imaging panels 30A and 30B, which present display images and capture video in the fields of view of the wearer. HMD device 34 includes wearable mount 36, which positions the imaging panels a short distance in front of the wearer's eyes. In FIG. 4, the wearable mount takes the form of conventional eyeglass frames.

No aspect of FIG. 3 or 4 are intended to be limiting in any sense, for numerous variants are contemplated as well. In some embodiments, for example, a vision system separate from imaging panels 30 may be used to capture the video; it may include suitable infrared or visible-light cameras, optics, etc. Further, while two separate imaging panels—one for each eye—are shown in the drawings, a binocular imaging panel extending over both eyes may be used instead.

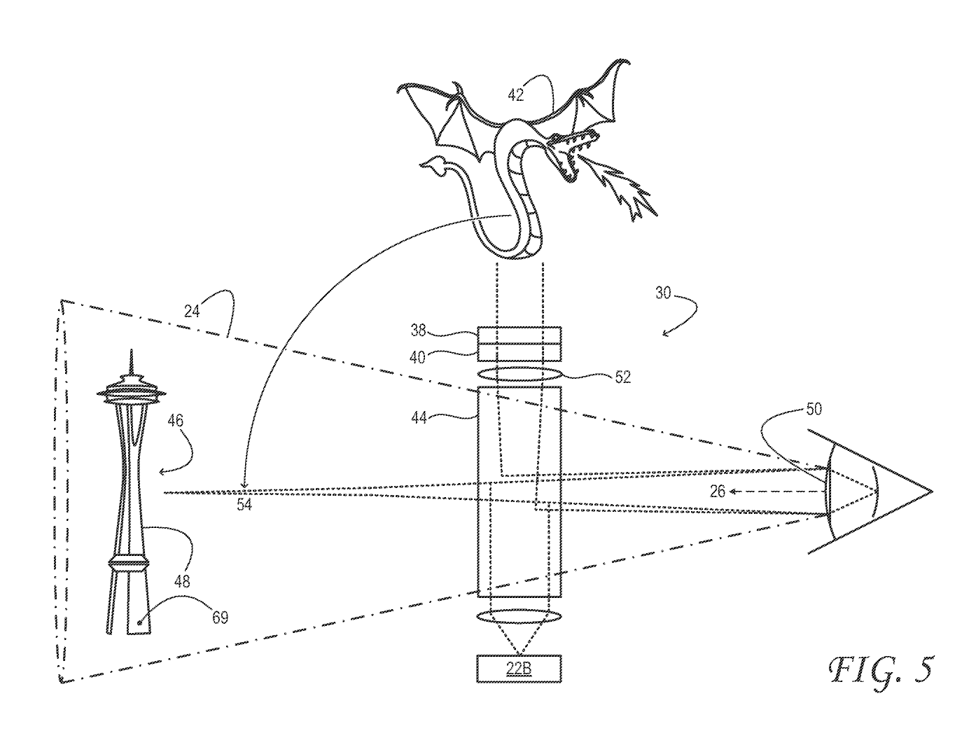

FIG. 5 shows aspects of an example imaging panel 30 in one embodiment. The imaging panel includes illuminator 38 and image former 40. In one embodiment, the illuminator may comprise a white-light source, such as a white light-emitting diode (LED). The illuminator may further comprise an optic suitable for collimating the emission of the white-light source and directing the emission into the image former. The image former may comprise a rectangular array of light valves, such as a liquid-crystal display (LCD) array. The light valves of the array may be arranged to spatially vary and temporally modulate the amount of collimated light transmitted therethrough, so as to form pixels of a display image 42. Further, the image former may comprise suitable light-filtering elements in registry with the light valves so that the display image formed is a color image. The display image 42 may be supplied to imaging panel 30 as any suitable data structure—a digital-image or digital video data structure, for example.

In another embodiment, illuminator 38 may comprise one or more modulated lasers, and image former 40 may be a moving optic configured to raster the emission of the lasers in synchronicity with the modulation to form display image 42. In yet another embodiment, image former 40 may comprise a rectangular array of modulated color LEDs arranged to form the display image. As each color LED array emits its own light, illuminator 38 may be omitted from this embodiment.

The various active components of imaging panel 30, including image former 40, are operatively coupled to sensory and control unit 32. In particular, the sensory and control unit provides suitable control signals that, when received by the image former, cause the desired display image to be formed.

Continuing in FIG. 5, imaging panel 30 includes multipath optic 44. The multipath optic is suitably transparent, allowing external imagery—e.g., a real image 46 of real object 48—to be sighted directly through it. In this manner, the real object may be sighted in field of view 24 of the wearer of the HMD device.

Image former 40 is arranged to project display image 42 into the multipath optic; the multipath optic is configured to reflect the display image to pupil 50 of the wearer of HMD device 16. In this manner, the multipath optic may be configured to guide both the display image and the real image along the same line of sight 26 to the pupil.

To reflect display image 42 as well as transmit real image 46 to pupil 50, multipath optic 44 may comprise a partly reflective, partly transmissive structure, such as an optical beam splitter. In one embodiment, the multipath optic may comprise a partially silvered mirror. In another embodiment, the multipath optic may comprise a refractive structure that supports a thin turning film.

In some embodiments, multipath optic 44 may be configured with optical power. It may be used to guide display image 42 to pupil 50 at a controlled vergence, such that the display image is provided as a virtual image in the desired focal plane. In other embodiments, the multipath optic may contribute no optical power, the position of the virtual display image determined by the converging power of lens 52. In one embodiment, the focal length of lens 52 may be adjustable, so that the focal plane of the display image can be moved back and forth in the wearer's field of view. In FIG. 5, an apparent position of virtual display image 42 is shown, by example, at 54.

The reader will note that the terms ‘real’ and ‘virtual’ each have plural meanings in the technical field of this disclosure. The meanings differ depending on whether the terms are applied to an object or to an image. A ‘real object’ is one that exists in an AR participant's surroundings. A ‘virtual object’ is a computer-generated construct that does not exist in the participant's physical surroundings, but may be experienced (seen, heard, etc.) via the AR technology. Quite distinctly, a ‘real image’ is an image that coincides with the physical object it derives from, whereas a ‘virtual image’ is an image formed at a different location than the physical object it derives from.

Returning now to FIG. 5, illuminator 38, image former 40, lens 52, and aspects of multipath optic 44 and sensory and control unit 32 together comprise a projector. The projector is configured to present virtual display image 42 in field of view 24 of the wearer of HMD device 16. By way of additional componentry and methods described hereinafter, the virtual image is positioned within a coordinate system, coincident with a second virtual image displayed in a second field of view.

As shown in FIG. 5, imaging panel 30 also includes camera 22B. The optical axis of the camera may be aligned parallel to the line of sight of the wearer of HMD device 16, such that the camera acquires video of the external imagery sighted by the wearer. Such imagery may include real image 46 of real object 48, as noted above. The video acquired may comprise a time-resolved sequence of images of spatial resolution and frame rate suitable for the purposes set forth herein. Sensory and control unit 32 may be configured to process the video to enact any of the methods set forth herein.

As HMD device 16 includes two imaging panels—one for each eye—it may also include two cameras. More generally, the nature and number of the cameras may differ in the various embodiments of this disclosure. One or more cameras may be configured to provide video from which a time-resolved sequence of three-dimensional depth maps is obtained via downstream processing. As used herein, the term ‘depth map’ refers to an array of pixels registered to corresponding regions of an imaged scene, with a depth value of each pixel indicating the depth of the corresponding region. ‘Depth’ is defined as a coordinate parallel to the optical axis of the camera, which increases with increasing distance from the camera. In some embodiments, one or more cameras may be separated from and used independently of one or more imaging panels.

In one embodiment, camera 22B may be a right or left camera of a stereoscopic vision system. Time-resolved images from both cameras may be registered to each other and combined to yield depth-resolved video. In other embodiments, HMD device 16 may include projection componentry that projects onto the surroundings a structured infrared illumination comprising numerous, discrete features (e.g., lines or dots). Camera 22B may be configured to image the structured illumination reflected from the surroundings. Based on the spacings between adjacent features in the various regions of the imaged surroundings, a depth map of the surroundings may be constructed.

In other embodiments, the projection componentry in HMD device 16 may be configured to project a pulsed infrared illumination onto the surroundings. Camera 22B may be configured to detect the pulsed illumination reflected from the surroundings. This camera, and that of the other imaging panel, may each include an electronic shutter synchronized to the pulsed illumination, but the integration times for the cameras may differ, such that a pixel-resolved time-of-flight of the pulsed illumination, from the source to the surroundings and then to the cameras, is discernable from the relative amounts of light received in corresponding pixels of the two cameras. In still other embodiments, the vision unit may include a color camera and a depth camera of any kind. Time-resolved images from color and depth cameras may be registered to each other and combined to yield depth-resolved color video. From the one or more cameras in HMD device 16, image data may be received into process componentry of sensory and control unit 32 via suitable input-output componentry.

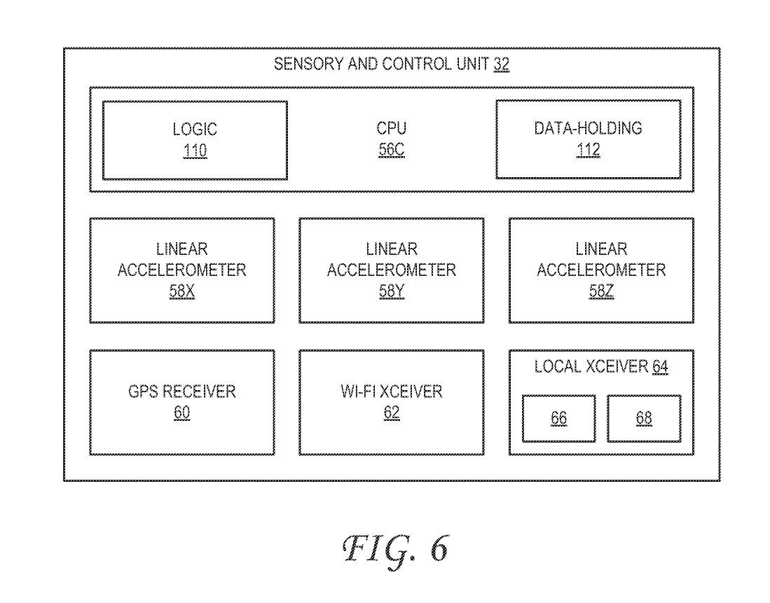

FIG. 6 shows aspects of sensory and control unit 32 in one embodiment. The illustrated sensory and control unit includes processing unit 56C with a logic subsystem 110 and data-holding subsystem 112, linear accelerometers 58X, Y, and Z, global-positioning system (GPS) receiver 60, Wi-Fi transceiver 62, and local transceiver 64. In other embodiments, the sensory and control unit may include other sensors, such as an eye tracker, a gyroscope, and/or a barometric pressure sensor configured for altimetry. From the integrated responses of the linear accelerometers—and gyroscope and barometric pressure sensor, if included—the sensory and control unit may track the movement of HMD device 16. Moreover, an eye tracker, when included in the sensory and control unit, may be used to locate the orientation of the line of sight of the wearer of the HMD device. If two eye trackers are included, one for each eye, then the sensory and control unit may also determine the focal plane of the wearer, and use this information for placement of one or more virtual images.

Local transceiver 64 includes local transmitter 66 and local receiver 68. The local transmitter emits a signal, which is received by compatible local receivers in the sensory and control units of other HMD devices—viz., those worn by other AR participants. Based on the strengths of the signals received and/or information encoded in such signals, each sensory and control unit may be configured to determine proximity to nearby HMD devices. In this manner, certain geometric relationships between a first and second participants' fields of view may be estimated. For example, the distance between the line-of-sight origins of the fields of view of two nearby participants may be estimated. Increasingly precise location data may be computed for an HMD device of a given participant when that device is within range of HMD devices of two or more other participants present at known coordinates. With a sufficient number of participants at known coordinates, the coordinates of the given participant may be determined—e.g., by triangulation.

In another embodiment, local receiver 68 may be configured to receive a signal from a circuit embedded in an object. In one scenario, the signal may be encoded in a manner that identifies the object and/or its location. Returning briefly to FIG. 5, a signal-generating circuit 69 embedded in an object may be used like local receiver 68, to bracket the location of an HMD device of a participant. In this case the object may be stationary. Further advantages accrue, however, when the object is movable. With a signal-generating circuit embedded in a movable, real object, a virtual object can be made to travel in relation to the real object. In another embodiment, the circuit embedded in an object may communicate with a server in AR system 10, in order to update the location of the object. In still other embodiments, at least some of the functionality here described for the local transceiver 64 may be enacted instead by Wi-Fi transceiver 62.

Proximity sensing as described above may be used to establish the location of one participant's HMD device relative to another's. Alternatively, or in addition, GPS receiver 60 may be used to establish the absolute or global coordinates of any HMD device. In this manner, the line-of-sight origin of a participant's field of view may be determined within a coordinate system shared by a second, independently oriented field of view. Use of the GPS receiver for this purpose may be predicated on the informed consent of the AR participant wearing the HMD device. Accordingly, the methods disclosed herein may include querying each AR participant for consent to share his location via AR system 10.

In some embodiments, GPS receiver 60 may not return the precise coordinates for the line-of-sight origin of a participant's field of view. It may, however, provide a zone or bracket within which the participant can be located more precisely, according to other methods disclosed herein. For instance, a GPS receiver will typically provide latitude and longitude directly, but may rely on map data for height. Satisfactory height data may not be available for every AR environment contemplated herein, so the other methods may be used in addition.

The configurations described above enable various methods for presenting real and virtual images correctly positioned with respect to each other. Accordingly, some such methods are now described, by way of example, with continued reference to the above configurations. It will be understood, however, that the methods here described, and others fully within the scope of this disclosure, may be enabled by other configurations as well. Naturally, each execution of a method may change the entry conditions for a subsequent execution and thereby invoke a complex decision-making logic. Such logic is fully contemplated in this disclosure. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

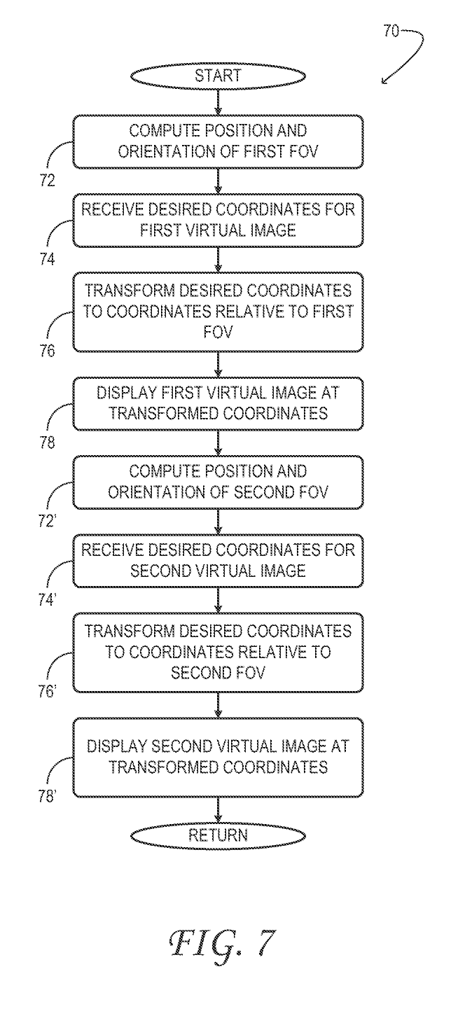

FIG. 7 illustrates an example method 70 for presenting real and virtual images correctly positioned with respect to each other. At 72 the position and orientation of a first field of view (FOV) are computed. The first field of view may be that of a first participant; the participant may be wearing an HMD device as described hereinabove. In one embodiment, the position and orientation of the first field of view may be expressed in terms of line-of-sight parameters associated with the first field of view. For example, three Cartesian coordinates (X₁, Y₁, Z₁) may be used to specify the origin of the line of sight; three additional parameters (ΔX, ΔY, ΔZ) may be used to specify the intersection of the line of sight with a unit sphere centered at (X₁, Y₁, Z₁). The manner of computing the position and orientation of the first field of view may differ in the different embodiments of this disclosure. In some embodiments, the computation may follow methods 72A and/or 72B, described hereinafter.

At 74 the desired coordinates for a first virtual image are received from the AR system. The first virtual image may correspond to a virtual object to be inserted in the first field of view by an application running within the AR system. In some embodiments, the desired coordinates may be received as absolute coordinates—Cartesian coordinates (X, Y, Z), or global coordinates (latitude, longitude, height), for example.

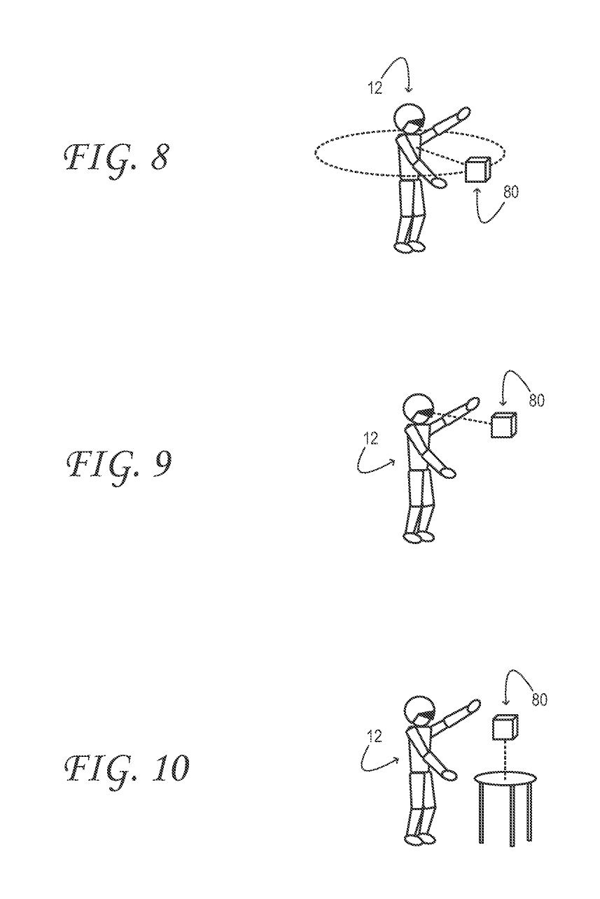

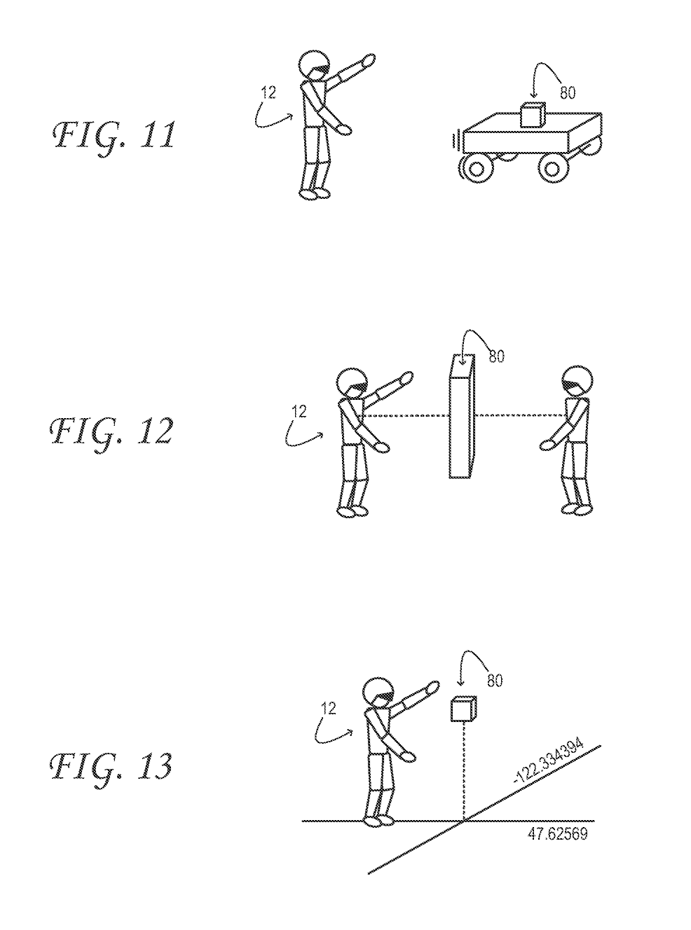

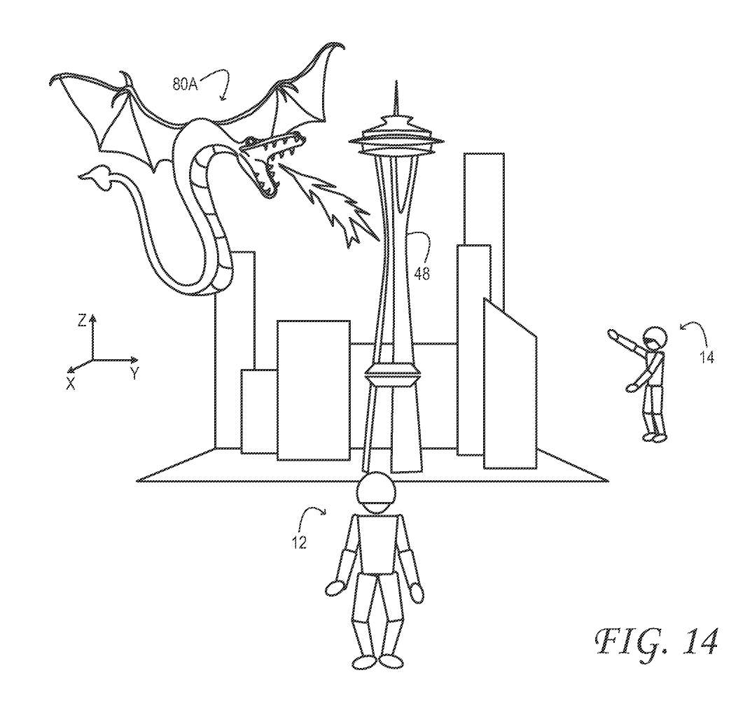

More generally, the coordinates of a virtual object in an AR environment may be specified with respect to at least six different frames of reference, which are mutually interconvertible provided that a shared, global coordinate system is available. FIG. 8 illustrates that the coordinates of the virtual object may be specified with respect to some locus on the participant's body. FIG. 9 illustrates that the coordinates of the virtual object may be specified with respect to the AR participant's gaze. In other words, the virtual object may stay at the same spot in the participants field of view regardless of where that participant is looking. FIG. 10 illustrates that the coordinates of the virtual object may be specified with respect to global ‘world space’. In this drawing, the virtual object floats a certain distance above the table. FIG. 11 illustrates that the coordinates of the virtual object may be specified with respect to a real object in world space. In this drawing, the virtual object is affixed to the side of the bus. FIG. 12 illustrates that the coordinates of the virtual object may be specified relative to locations of two AR participants. Here, the virtual object is a floating wall that stays between the participants. FIG. 13 illustrates that the coordinates of the virtual object may be specified with respect to geography. In this drawing, the virtual object may reside at a certain latitude, longitude, and predetermined height. In other examples, the latitude, longitude, and/or height may be relative to another virtual image.

Returning now to FIG. 7, at 76 of method 70, the desired coordinates for the first virtual image are transformed to coordinates relative to the first field of view. In one embodiment, the desired coordinates may be transformed to spherical polar coordinates (R, θ, φ) defined relative to the line of sight associated with the first field of view. For instance, R may be the distance from the line-of-sight origin, θ the angle measured from the line of sight in a plane also containing the first participant's interocular axis, and φ the angle measured from a line normal to that plane. At 78 the first virtual image is displayed at the transformed coordinates, within the first field of view.

The foregoing aspects of method 70 may be enacted in the HMD device worn by the first participant. By contrast, subsequent aspects of the method may be enacted in an HMD device worn by a second participant. At 72′ the position and orientation of a second field of view is computed. In one embodiment, the second field of view may be that of the second participant. In other embodiments, the second field of view may be that of a stationary observer—e.g., PC 18 in FIG. 1.

At 74′ desired coordinates for a second virtual image are received from the AR system. The second virtual image may correspond to a virtual object to be inserted in the second field of view by an application running within the AR system. It may be the same application that inserts the first virtual image in the first field of view. Moreover, the first and second virtual images may correspond to the same virtual object. They may differ, however, in perspective and/or illumination to simulate the appearance of the same physical object being sighted from different points of view.

At 76′ the desired coordinates for the second virtual image are transformed to coordinates relative to second field of view, and at 78′, the second virtual image is displayed at the transformed coordinates. From 78′ the method returns.

In embodiments in which the first and second virtual images are images of the same virtual object, these images may be positioned coincidently within a coordinate system shared by the HMD devices of the first and second participants. This scenario is illustrated in FIG. 14, which shows a shared coordinate system on which a real object 48 and a virtual object 80A are arranged.

With the systems and methods disclosed herein, the same coordinate system may be shared among a plurality of AR participants. The coordinate system can be used for placement of a virtual object, as described above, or an audio cue to be heard by a participant as he sights or draws near to the location on the coordinate system where the cue was deposited. The coordinate system may be shared automatically by participants in the same room, participants in the same meeting invite, friends, etc. However, it may also be desirable to control which of a plurality of participants has access to the common coordinate system and to virtual objects placed on it. Naturally, the same coordinate system can be shared among a plurality of applications running on one or more HMD devices in an AR system.

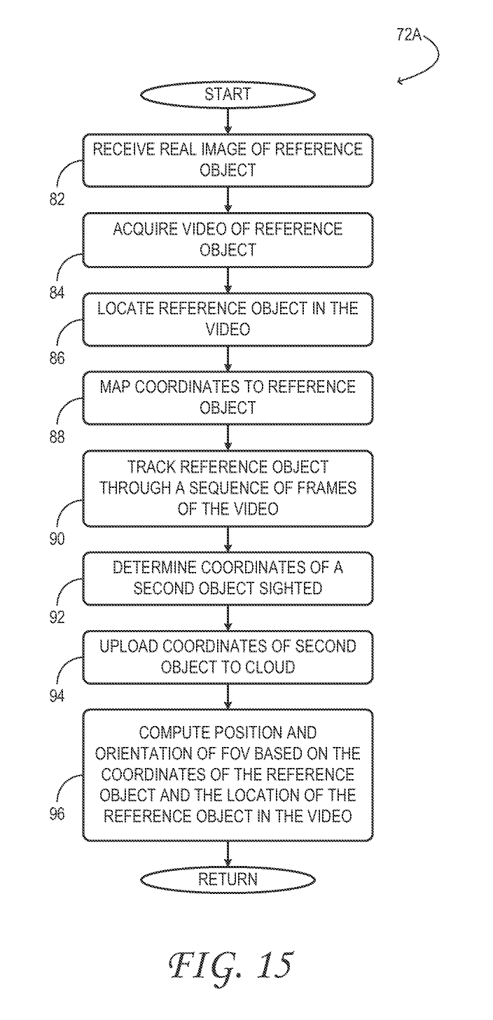

FIG. 15 illustrates an example method 72A for computing the position and orientation of a field of view. The field of view may be that of an AR participant—viz., one of a plurality of participants each interacting with the same AR system.

At 82 of method 72A, a real image of an object is received in the field of view. In one embodiment, the participant sights the object through the HMD device he is wearing. In method 72A, the object sighted is a reference object; it may define at least an origin of a coordinate system to be shared among a plurality of HMD devices in the AR system. For instance, if the object has a conspicuous feature—e.g., a sharp point on top—then that feature may be chosen as the origin of the coordinate system. Alternatively, the origin may be a point lying a predetermined distance above or below the conspicuous feature, or offset from the conspicuous feature by a predetermined distance in a predetermined direction. In some embodiments, the object, if sufficiently asymmetric, may also define the orientation of the coordinate system—e.g., the sharp point may point in the direction of the positive Z axis.

In some embodiments, the reference object may be a stationary object such as a building or other landmark, or in an indoor setting, a corner of a room. In other embodiments, the reference object may be a movable object—i.e., autonomously moving or movable by force.

No aspect of the foregoing description should be interpreted in a limiting sense, for numerous variations are contemplated as well. In some embodiments, the orientation of the coordinate system may be defined based on features of two or more objects sightable together and/or a surface mapping of an observed scene. In other words, different aspects of the scene may serve collectively as the reference object. In other embodiments, the reference object may be a computer-recognizable image rendered in any manner—in paint, or on a television, monitor, or other electronic display. In other embodiments, the reference object may be a three-dimensional object discovered through segmentation and/or object recognition. In some embodiments, the reference object may be one of the AR participants, or even a recognizable non-participant.

At 84 video of the reference object is acquired. The video may be acquired with a camera as described hereinabove, arranged to capture real-world imagery in the participant's field of view. In one embodiment, the optical axis of the camera may be aligned parallel to the participant's line of sight. At 86 the reference object is located in the video. To locate the reference object, any suitable image processing technology may be used.

At 88 coordinates that define the reference object's position and orientation within the coordinate system are mapped to the object. The mapping may be entered in an appropriate data structure in code running on the HMD device of the participant. In some embodiments, the coordinates mapped to the reference object may have been assigned to the object elsewhere in the AR system—in an HMD device of another participant or in the cloud, which maintains an accurate map of the local space that the AR participants occupy. In one embodiment, the coordinates may be transmitted to the HMD device in real time from one or more of these locations. The video of the reference object together with the coordinates assigned to the reference object may implicitly or explicitly define the position and orientation of the first field of view within the coordinate system.

In one scenario, a reference object may be located and coordinates mapped to it all in one frame of the video. At 90, however, the reference object is tracked through a sequence of frames of the video. This aspect enables coordinates to be assigned to subsequent objects that may not be visible in the frame in which coordinates were mapped to the reference object. Accordingly, at 92 the coordinates of a second object sighted in the same field of view are determined. The coordinates of the second object may be determined based on those mapped to the reference object and on the displacement of the real image of the reference object relative to that of the second object, as received in the field of view. At 94 the coordinates of the second object are uploaded to the cloud. In this manner—i.e., by sighting a third and fourth object, etc.—an extensive mapping of the AR environment may be accumulated over numerous sightings of the environment and maintained in the cloud for subsequent download to the same and other HMD devices.

At 96 the position and orientation of the participant's field of view is computed based on the coordinates of the reference object and the location of the real image of the reference object in the video. From 96, method 72A returns.

Method 72A may be executed for reference objects sighted in different fields of view, concurrently or sequentially. In one embodiment, a first real image of a given reference object may be received and used, as described above, to compute the position and orientation of a first field of view. In addition, a second real image of the same reference object may be received in a second field of view oriented independently relative to the first field of view. The first and second fields of view need not be contiguous, and may exclude at least some space between them. In other words, the first and second fields of view may have a discontinuous intersection with a plane bisecting the coordinate system. Moreover, the second real image may differ from the first, consistent with the same reference object being viewed from different perspectives. Accordingly, an AR application compatible with this method may initially prompt each user to sight a commonly sightable object to be used as the reference object—i.e., to establish the origin and/or orientation of the shared coordinate system.

If two or more AR participants sight the same reference object, then the approach here illustrated may be used to refine the mappings used on the HMD devices of one or both HMD participants. If, as a result of this process, the computed coordinates of another commonly sighted object should differ from one field of view to the next—i.e., in two HMD devices—then a negotiation protocol may be invoked to resolve the difference by assigning intermediate coordinates to that object.

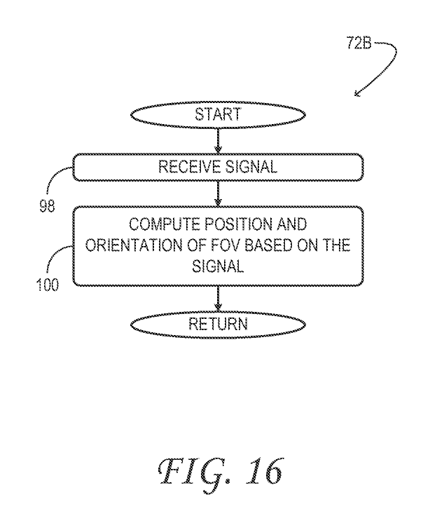

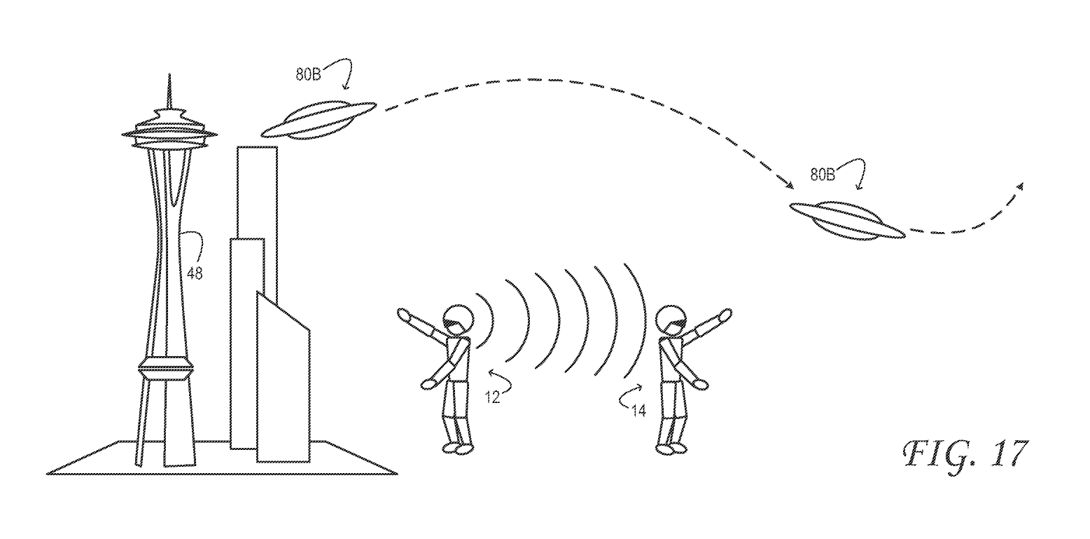

FIG. 16 illustrates another example method 72B for computing the position and orientation of a field of view. This method does not rely on a common reference object being sightable by a plurality of AR participants. Instead, it relies on external sensing of the location of a participant's HMD device to bracket the position and/or orientation of the field of view of that participant within the shared coordinate system. Accordingly, the first and second fields of view may be entirely non-overlapping in the embodiment now described. Nevertheless, methods 72A and 72B may be used together in some embodiments.

At 98 of method 72B, a signal is received in the HMD device of a participant. In one embodiment, the signal received is a GPS signal from a plurality of GPS satellites; based on the signal, componentry within the HMD device computes at least the line-of-sight origin of the field of view of the participant.

In another embodiment, the signal received is from a local transmitter of another participant's HMD device. Based on the strength of that signal, proximity to the HMD device of the other participant may be determined. This approach is especially useful if first and second AR participants are in proximity to each other, and if the first participant can sight a reference object but the second participant cannot. This scenario is illustrated by example in FIG. 17, where first participant 12 can sight real object 48, but second participant 14 cannot. Here, an object mapping computed from the first participant's first field of view, in any suitable manner (via 72A, for example), may be used to compute the position and/or orientation of the second participant's second field of view.

Continuing in FIG. 17, virtual object 80B is represented as passing out of the field of view of first participant 12 and into the field of view of second participant 14. According to the methods set forth herein, AR system 10 negotiates the path of the virtual object within the shared coordinate system so that the first participant sees it gradually leaving his field of view, and the second participant sees it gradually entering his field of view. AR system 10 enables the appropriate path to be computed even when a relatively large gap is present between the participants' fields of view.

Returning now to FIG. 16, at 100, the position and orientation of the field of view is computed based on the signal, and from 100, method 72B returns. Applied in the context of method 70, method 72B enables a shared, global coordinate system to be constructed without requiring a global map to be grown by interconnecting various fields of view. Among the many advantages of this approach is that it enables a virtual object (80B in FIG. 17) to be tracked as it moves between discontinuous fields of view.

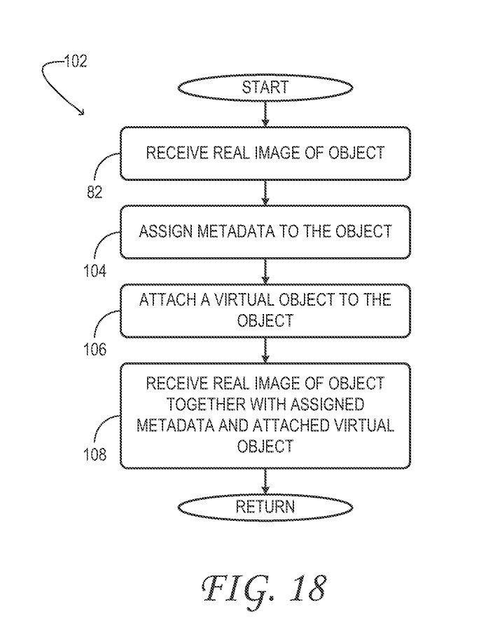

FIG. 18 illustrates an example method 102 for passing a virtual object between first and second AR participants. This method may be enacted in an AR system in which a common coordinate system is shared among the HMD devices of a plurality of participants. Method 102 and elements thereof may be used together with any of the other methods disclosed herein.

At 82 of method 102, a real image of an object is received in the field of view of the first participant. At 104 metadata is mapped to the object by request of the first participant. Various forms of metadata may be mapped to the coordinates of a sighted object—a landmark name or street address, for example. At 106 a virtual object is attached to the object by request of the first participant. In this manner, participants that cannot directly sight the object may still be able to see virtual images mapped to it. One example to illustrate this point is a virtual balloon held by a long string by a person standing in a gulley. The virtual balloon would still be visible by a participant at ground level, even though the (real) holder of the balloon may not be visible. In other embodiments, a virtual object may be created at or moved to a particular set of coordinates by an AR participant. Those coordinates may be stored by AR system 10—in cloud 20 or in the participant's HMD device, for example. By the methods described herein, the participant could leave the virtual object at the given coordinates for any length of time, and on returning to the coordinates, find the virtual object where he left it. This is due to the fact that the shared coordinate system of the present disclosure completely defines the object's position in the AR environment, not merely by latitude and longitude.

Continuing in FIG. 18, at 108 a real image of object, together with a first virtual image representing the assigned metadata and a second virtual image corresponding to the attached virtual object, is received by the second participant. From 108 the method returns.

The methods described herein may be tied to AR system 10—a computing system of one or more computers. These methods, and others embraced by this disclosure, may be implemented as a computer application, service, application programming interface (API), library, and/or other computer-program product.

FIGS. 1 and 6 show components of an example computing system that may enact the methods described herein (e.g., PC 18 and cloud 20 of FIG. 1, and sensory and control unit 32 of FIG. 6. As an example, FIG. 6 shows a logic subsystem 110 and a data-holding subsystem 112; PC 18 may also include a logic subsystem and a data-holding subsystem. Cloud 20 may include a plurality of logic subsystems and data-holding subsystems.

Logic subsystem 110 may include one or more physical devices configured to execute instructions. For example, the logic subsystem may be configured to execute instructions that are part of one or more applications, services, programs, routines, libraries, objects, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud-computing system.

Data-holding subsystem 112 may include one or more physical, non-transitory, devices configured to hold data and/or instructions executable by the logic subsystem to implement the herein described methods and processes. When such methods and processes are implemented, the state of the data-holding subsystem may be transformed—to hold different data, for example.

Data-holding subsystem 112 may include removable media and/or built-in devices. The data-holding subsystem may include optical memory devices (CD, DVD, HD-DVD, Blu-Ray Disc, etc.), semiconductor memory devices (RAM, EPROM, EEPROM, etc.) and/or magnetic memory devices (disk drive, tape drive, MRAM, etc.), among others. The data-holding subsystem may include devices with one or more of the following characteristics: volatile, nonvolatile, dynamic, static, read/write, read-only, random access, sequential access, location addressable, file addressable, and content addressable. In some embodiments, the logic subsystem and the data-holding subsystem may be integrated into one or more common devices, such as an application specific integrated circuit (ASIC), or system-on-a-chip.

Data-holding subsystem 112 may also include removable, computer-readable storage media used to store and/or transfer data and/or instructions executable to implement the herein described methods and processes. The removable, computer-readable storage media may take the form of CDs, DVDs, HD-DVDs, Blu-Ray Discs, EEPROMs, and/or removable data discs, among others.

It will be appreciated that data-holding subsystem 112 includes one or more physical, non-transitory devices. In contrast, in some embodiments aspects of the instructions described herein may be propagated in a transitory fashion by a pure signal—e.g., an electromagnetic or optical signal—that is not held by a physical device for at least a finite duration. Furthermore, certain data pertaining to the present disclosure may be propagated by a pure signal.

The terms ‘module,’ ‘program,’ and ‘engine’ may be used to describe an aspect of a computing system that is implemented to perform a particular function. In some cases, such a module, program, or engine may be instantiated via logic subsystem 110 executing instructions held by data-holding subsystem 112. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms ‘module,’ ‘program,’ and ‘engine’ are meant to encompass individual or groups of executable files, data files, libraries, drivers, scripts, database records, etc.

It will be appreciated that a ‘service’, as used herein, may be an application program executable across multiple user sessions and available to one or more system components, programs, and/or other services. In some implementations, a service may run on a server responsive to a request from a client.

When included, a display subsystem may be used to present a visual representation of data held by data-holding subsystem 112. As the herein described methods and processes change the data held by the data-holding subsystem, and thus transform the state of the data-holding subsystem, the state of the display subsystem may likewise be transformed to visually represent changes in the underlying data. The display subsystem may include one or more display devices utilizing virtually any type of technology. Such display devices may be combined with logic subsystem 110 and/or data-holding subsystem 112 in a shared enclosure, or such display devices may be peripheral display devices.

When included, a communication subsystem may be configured to communicatively couple the computing system with one or more other computing devices. The communication subsystem may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow the computing system to send and/or receive messages to and/or from other devices via a network such as the Internet.

It will be understood that the articles, systems, and methods described hereinabove are embodiments—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A method for presenting real and virtual images correctly positioned with respect to each other, the method comprising:
in a first field of view, receiving a first real image of an object and displaying a first virtual image, the object defining at least an origin of a coordinate system; and
in a second field of view oriented independently relative to the first field of view, receiving a second real image of the object and displaying a second virtual image, the first and second virtual images positioned coincidently within the coordinate system.

2. The method of claim 1 wherein the first field of view is a field of view of an augmented-reality participant, wherein the first virtual image is displayed via a see-through, head-mounted display device worn by the participant, and wherein the participant sights the object through the HMD device.

3. The method of claim 1 wherein the object also defines an orientation of the coordinate system.

4. The method of claim 1 wherein the first and second fields of view exclude at least some space between them.

5. The method of claim 1 wherein the object is stationary with respect to the coordinate system.

6. The method of claim 1 further comprising:
acquiring video of the object;
locating the object in the video; and
in one frame of the video, mapping coordinates to the object that define its position and orientation within the coordinate system.

7. The method of claim 6 further comprising assigning metadata to the object.

8. The method of claim 6 further comprising attaching a virtual object to the object.

9. The method of claim 6 wherein the video of the object together with the coordinates mapped to the object define the position and orientation of the first field of view within the coordinate system, the method further comprising:
transforming desired coordinates of the first virtual image to coordinates relative to the first field of view, wherein displaying the first virtual image comprises displaying the first virtual image at the transformed coordinates.

10. The method of claim 6 further comprising tracking the object through a sequence of frames of the video.

11. The method of claim 6 wherein the object is a first object, the method further comprising:
determining coordinates within the coordinate system of a second object also sighted by the participant based on the mapped coordinates of the first object and on the displacement of the first real image relative to a real image of the second object received in the first field of view.

12. The method of claim 6 wherein mapping the coordinates to the object includes receiving the coordinates of the object as sighted in the second field of view.

13. The method of claim 6 further comprising:
maintaining the coordinates of the object on a network-accessible computer; and
downloading the coordinates from the network-accessible computer in real time.

14. An augmented-reality system comprising:
an optic through which an object is sighted in a first field of view;
a camera configured to acquire video of the object;
a sensor configured to bracket a position and/or orientation of the first field of view within a coordinate system shared by a second, independently oriented field of view; and
a projector configured to display a first virtual image in the first field of view, the first virtual image positioned within the coordinate system coincident with a second virtual image displayed in the second field of view, the optic, camera, sensor, and projector coupled in a see-through, head-mounted display (HMD) device.

15. The system of claim 14 wherein the first and second fields of view are non-overlapping.

16. The system of claim 14 wherein the sensor includes a global positioning system receiver.

17. The system of claim 14 wherein the sensor includes a receiver configured to sense proximity to another HMD device.

18. The system of claim 14 wherein the sensor includes a receiver configured to read data from a circuit embedded in the object that transmits the object's coordinates and/or identity.

19. The system of claim 14 further comprising a computer external to the HMD device and configured to maintain a mapping of an environment for access by the HMD device.

20. An augmented-reality system comprising:
a first head-mounted display device, including:
a first optic in which an object is sighted in a first field of view,
a first camera configured to acquire video of the object,
a first projector configured to display a first virtual image, the object defining at least an origin of a coordinate system; and
a communication subsystem configured to communicate with a remote computer, the remote computer configured to communicate with a second head-mounted display device having a second optic in which the object is sighted in a second field of view oriented independently relative to the first field of view, a second camera configured to acquire video of the object, and a second projector configured to display a second virtual image, the first and second virtual images positioned coincidently within the coordinate system; the remote computer configured to maintain, for access by the first head-mounted display device and the second head-mounted display device, a mapping of an environment in which the augmented-reality system is used.
